(19) United States
(12) Patent Application Publication
(10) Pub. No.: US 2008/0062098 A1
(43) Pub. Date: Mar. 13, 2008

(54) Liquid Crystal Display Apparatus

(75) Inventor: Osamu Kobayashi, Azumino-Shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SEIKO EPSON CORPORATION, Tokyo (JP)

(21) Appl. No.: 11/574,927

(22) PCT Filed: Sep. 27, 2005
(86) PCT No.: PCT/JP05/17718

§ 371 Date: Mar. 8, 2007

(30) Foreign Application Priority Data
Sep. 30, 2004 (JP) 2004-286357

(51) Int. Cl. G09G 3/36

(52) U.S. Cl. 345/87

(57) ABSTRACT

A plurality of signal wires of a liquid crystal display apparatus are constituted by a plurality N of switching wires (SW1-SW3) and a plurality P of driving wires (L1-L4). The driving wires (L1-L4) are connected to P respective ones (e.g., ta1-ta4) of the plurality of signal input terminals via P switching elements (tr1-tr4). The N switching wires (SW1-SW3) are connected to the input terminals (gate electrodes) of the P switching elements connected to the respective different driving wires (L1-L4). Signals from an external control circuit (not shown) are used to control the switching elements via a driving circuit, while driving signals are supplied to the P driving wires. In this way, there is provided a liquid crystal display apparatus wherein some of the signal wires are driven in a time division manner so as to reduce the number of signal wires and wherein a part of the peripheral area of the board where the signal wires are formed is reduced in size so as to reduce the wire resistances of common wires and also reduce the size of the peripheral area.

### FIELD OF THE INVENTION

The present invention relates to a liquid crystal display (CD) apparatus. More particularly, the present invention relates to an LCD apparatus provided with, on the periphery of the display part of its LCD panel, a plurality of signal input terminals receiving scan signals or video signals. Each of the signal input terminals is coupled to a plurality of signal wires in a time division manner, thereby reducing the number of the signal wires. Accordingly, an area occupied by the plurality of signal wires in a peripheral area of one board of the LCD panel is reduced to leave a wider remaining portion in the peripheral area, thereby reducing the wire resistances of common wires and also reducing the size of the peripheral area.

### RELATED ART

LCD apparatuses are used as displays included in various types of electronic equipment. With intensified demands for smaller electronic equipment in recent years, demands for smaller LCD apparatuses used as their displays have also increased. A typical LCD apparatus includes an LCD panel having a pair of boards with a liquid crystal layer interposed therebetween, and a driver integrated circuit (IC) for driving the LCD panel. Space economical structures for such an LCD apparatus are being pursued with chip-on-glass (COG) mounting, by which a driver IC is directly disposed on one board out of the pair of boards included in the LCD panel.

Of a pair of rectangular boards included in an LCD panel of a COG LCD apparatus, a first board is larger than a second board and a driver IC is provided to the periphery of a part (display part) where the second board overlaps the first board, that is, the peripheral area of the first board. Provided on the first board are a plurality of signal input terminals to provide the display part with predetermined driving signals and also a plurality of signal wires to couple the plurality of signal input terminals to a plurality of signal output terminals of the driver IC to generate and output the driving signals to be provided to the individual input terminals.

The plurality of signal input terminals are formed by extending the signal wires in the display part to the outside of the display part and arranged in parallel with the sides of the rectangular display part. For example, an active-matrix LCD apparatus needs three types of signal input terminals, i.e., input terminals for scan signals, display signals, and common electrode driving signals. The active-matrix LCD apparatus is therefore provided with, for example, a plurality of scan signal input terminals arranged in parallel with a specific side of the rectangular display part, a plurality of display signal input terminals arranged in parallel with a side adjacent to the specific side, and scan-line signal wires and display signal wires arranged in a matrix. The apparatus is also provided with common electrode driving signal input terminals on an end of the string of the scan signal or display signal input terminals.

FIG. 3 is a plane view showing a related-art active-matrix LCD apparatus 31 packaged by COG mounting. The LCD apparatus 31 includes an LCD panel 34 and three driver ICs 35, 36, and 37. The LCD panel 34 includes a first board 32 and a second board 33 that is smaller than the first board 32 and overlaps the first board 32 with a liquid crystal layer interposed therebetween to provide a display part. Disposed on the first board 32, the driver ICs 35, 36, and 37 generate and output driving signals to drive the LCD panel 34.

In the LCD panel 34, the smaller second board 33 is placed on one side of the larger first board 32 and also on almost the center of that side, leaving three peripheral areas A11, A12, and A13 on the periphery of the display part on the first board 32. In the LCD panel 34, a plurality of scan signal input terminals ta extended from the display part are arranged along the periphery of the display part, i.e. the sides of the second board 33, in the two opposing peripheral areas A11 and A12. Also, a plurality of display signal input terminals tb extended from the display part are arranged along the periphery of the display part in the other peripheral area A13.

Among the driver ICs, two are scan driver ICs 36 and 37 to generate and output scan signals and the other is a display driver IC 35 to generate and output display signals. The three driver ICs 35 to 37 are placed in the peripheral area A13 having the string of the display signal input terminals on the first board 32. Providing all of the driver ICs 35 to 37 in one peripheral area A13 can reduce the width of the first board 32 and thus can make the LCD apparatus 31 smaller.

Provided on the outer periphery of the peripheral areas A11 and A12 having the scan signal input terminals ta are common driving signal input terminals tc that provide a common electrode provided to the second board 33 with common driving signals. Provided in the peripheral area A13 having the driver ICs 35 to 37 are common terminals td that receive the common driving signals input from an external control circuit (not shown).

Since the display driver IC 35 faces the string of display signal input terminals, signal wires coupling the output terminal of the IC 35 and the display signal input terminals tb are arranged linearly in the area R11 shown in FIG. 3. Meanwhile, since the scan driver ICs 36 and 37 do not face the strings of scan signal input terminals, signal wires coupling the output terminals of the ICs 36 and 37 and the scan signal input terminals ta are laid in the peripheral areas A11 and A12 where the input terminals ta are provided from one end of each string. Specifically, the signal wires start from the output terminals of the scan driver ICs 36 and 37, go through one end of each of the peripheral areas A11 and A12 where the input terminals ta are provided (see the regions R12L and R12R in FIG. 3), and are laid in the peripheral areas A11 and A12 to reach each of the input terminals ta (see the regions R13L and R13R in FIG. 3).

A common wire 38 coupling the common driving signal input terminals tc and the common terminals td starts from the terminals td, goes through one end of each of the peripheral areas A11 and A12 where the input terminals ta are provided, and is laid in regions outside of the regions R13L and R13R to reach the common driving signal input terminals tc at the other end of each of the peripheral areas A11 and A12.

An example of the LCD apparatus 31 including the plurality of driver ICs 35 to 37 in one peripheral area A13 on the first board 32 included in the LCD panel 34 is described in Patent Document 1.

FIG. 4 is an enlarged plane view showing the pattern of signal wires in the peripheral area A12 where the scan signal input terminals ta are provided. Since the signal wires in the peripheral area A11 on the left of the second board 33 and the signal wires in the peripheral area A12 on the right of the second board 33 are symmetric referring to FIG. 3, the signal wires in the peripheral area A12 will now be described as a representative. FIG. 4 describes signal wires s1 to s5 (also referred to collectively as the “signal wire s”) coupled to the five scan signal input terminals ta1 to ta5 (also referred to collectively as the “terminal ta”).

The wire part e1 coupled to the scan signal input terminal ta1 at the other end of each string of the scan signal input terminals will now be described. The wire part s1 from one end of each string of the scan signal input terminals to the input terminal ta includes a first linear portion sa1 and a second linear portion sb1. The first linear portion sa1 extends from one end to the other end of each string of the scan signal input terminals in parallel with the direction in which the input terminal is arranged. The second linear portion sb1 extends at a predetermined angle to the direction. The predetermined angle of the second linear portion sb1 is set so that one end of the first linear portion sa1 can be coupled to the target scan signal input terminal ta1. The second linear portion sb1 is wider than the first linear portion sa1. The other wire parts s2 to s5 have a shape similar to that of the wire part 91. The wire parts s1 to s5 can be formed at the same time on a single layer by a thin-film forming technology.

The common wire 38 includes a linear portion 38a and a nearly triangular coupling portion 38b. The linear portion 38a extends from one end to the other end of each string of the scan signal input terminals in parallel with the direction dl in which the scan signal input terminal ta1 is arranged. The coupling portion 38b is provided at the other end of each string of the scan signal input terminals. The common wire 38 can be formed at the same time, in the same manner as the wire parts s1 to s5, on a single layer by a thin-film forming technology.

Since the wire part s1 from one end of each string of the scan signal input terminals to the signal input terminal includes the first linear portion sa1 and the second linear portion sb1 that is wider than the first linear portion sa1 which are coupled to each other, wire resistances decrease directly before the scan signal input terminal, thereby preventing the voltage of scan signals from dropping directly before the input terminal ta1. In the same manner, since the common wire 38 from one end of each string of the scan signal input terminals to a common driving signal input terminal tc1 includes the linear portion 38a and the nearly rectangular portion 38b having a larger width which are coupled to each other, wire resistances decrease directly before the common driving signal input terminal, thereby preventing the voltage of common driving signals from dropping directly before the common driving signal input terminal. It is therefore possible to provide the display part with the scan signals and common driving signals properly, thereby preventing the display quality of the LCD apparatus 31 from deteriorating.

[Patent Document 1] JP-2003-241217-A (claims, sections 0028 to 0036, FIGS. 1 to 7)

### DISCLOSURE OF THE INVENTION

### Problems to be Solved

It is required that the LCD apparatus 31 provide higher definition image displays. To achieve higher definition image displays, it is necessary to increase the number of display lines in the display part and also increase the number of pixels on each display line. To increase the display lines and pixels, it is necessary to increase the number of the scan signal input terminals ta and the number of the display signal input terminals tb. In line with the increased scan signal input terminals ta, the number of signal wires coupling the scan driver ICs 36 and 37 and the input terminals ta also increases, thereby widening an area for providing the signal wires and narrowing down an area for providing the common wire 38 in the peripheral areas A11 and A12 where the input terminals ta are provided.

Furthermore, it is required that the LCD apparatus 31 be space-economical as electronic equipment to which the apparatus is mounted becomes smaller. To provide a more space-economical structure, the first board 32 may be made smaller, for example. However, a smaller first board 32 means that the peripheral areas A11 and A12 on the periphery of the display part are also made smaller. Here, the number of the signal wires is fixed. Referring to FIG. 5 showing coupling between signal input terminals ta1 to taM of a related-art LCD panel and signal wires s1 to sM, for example, the signal wires s9 to sM and the input terminals ta1 to taM of the LCD panel are 1:1. In this case, as shown in FIG. 6, input signals, e.g. a to l, input to the LCD apparatus 31 in one field period are separately input to the input terminals ta1 to taM of the LCD panel. Since there is a limit for narrowing down the width of the signal wires and a gap therebetween, an area for providing the plurality of signal wires in the peripheral areas A11 and A12 cannot be made significantly smaller. Meanwhile, the smaller board 32 results in a smaller area for providing the common wire 38.

The smaller area for providing the common wire 38 makes the width of the linear portion of the common wire 38 smaller, thereby increasing wire resistances in the linear portion and increasing the drop in the voltage of common driving signals in that portion. Accordingly, common driving signals cannot be provided to the common driving signal input terminal to properly, which leads to deterioration of the display quality of the LCD apparatus 31.

Taking the above-described problems in the related art into consideration, the inventor of the present invention has recognized that the plural number of the signal wires can be reduced by using the wires in a time division manner to achieve the present invention. This is because the problems in the related art are attributed to the fact that the plural number of the signal wires equals the plural number of the signal input terminals of the display part included in the LCD panel.

The present invention is intended to reduce the plural number of signal wires coupled to a plurality of signal input terminals of an LCD panel by sharing and driving the signal wires in a time division manner. Accordingly, the invention is also intended to provide an LCD apparatus in which an area occupied by the plurality of signal wires in a peripheral area of one board of its LCD panel is reduced to leave a wider remaining portion in the peripheral area, thereby widening common wires to reduce their wire resistances and also reducing the size of the peripheral area.

### Means to Solve the Problems

The present invention provides the following structures, addressing the above-mentioned problems. A liquid crystal display (LCD) apparatus according to claim 1 of the invention includes an LCD panel having a first board and a second board that is smaller than the first board and overlaps the first board with a liquid crystal layer therebetween to provide a display part, and a plurality of signal input terminals that are provided on a periphery of the display part to receive a scan signal or a video signal. In the LCD panel, a driver circuit that processes a control signal provided externally and generates a driving signal to drive the LCD panel and a switching signal, a plurality of driving wires through which the driving signal from the driver circuit is sent, and a plurality of switching wires through which the switching signal from the driving circuit is sent are provided on the first board. A total of the plurality of driving wires and the plurality of switching wires is less than the number of the plurality of signal input terminals. Each of the plurality of signal input terminals is coupled to the plurality of driving wires via a switching element. The plurality of driving wires are synchronized to the switching signal by the switching element and switchingly coupled to the plurality of signal input terminals in a time division manner.

While the plurality of signal wires driven in a time division manner may be coupled to either video signal lines or scan signal lines of the LCD panel it is preferable that the wires be coupled to the scan signal lines, since the signals provided to the video signal lines are analog gradation signals and require a high switching frequency for time division.

According to claim 2 of the invention, in the LCD apparatus according to claim 1 with the number of the plurality of driving wires being P and the number of the plurality of switching wires being N, each P of the plurality of signal input terminals are coupled to the individual driving wires via the switching element, and each of the N switching wires is coupled to an input terminal of the P switching elements coupled to the individual driving wires. The switching element is controlled from the driver circuit via the N switching wires and the P driving wires are provided with the driving signal to provide the plurality of signal input terminals with the driving signal in a time division manner.

According to claim 3 of the invention, in the LCD apparatus according to claim 2, the plurality of signal input terminals each P of which are coupled to the individual driving wires via the switching element are adjacent to each other.

According to claim 4 of the invention, in the LCD apparatus according to any of claims 1 to 3, the switching element is a thin film transistor (ITT).

According to claim 5 of the invention, in the LCD apparatus according to claim 2 with the number of the plurality of signal input terminals being M, the numbers M, N, and P satisfy the formula M/N≦P.

Here, when M/N=P, the number of switching elements coupled (i.e. the number of input terminals) is the same for every driving wire. When M/N<P, the number of switching elements coupled may be different for the individual driving wires.

### ADVANTAGES OF THE INVENTION

The above-described structures according to the invention provide the following advantages. According to claim 1 of the invention, the plurality of driving wires are switchingly coupled to the plurality of signal input terminals provided to the periphery of the display part included in the LCD panel in a time division manner, whereby the number of signal wires, i.e., the driving wires and switching wires, can be smaller than the number of the signal input terminals. Accordingly, an area for providing the plurality of signal wires can be reduced. Consequently, a wider remaining portion is left in the peripheral area, thereby reducing the wire resistances of common wires and also reducing the size of the peripheral area.

According to claim 2 of the invention, the simple structure makes it possible to reduce the number of the signal wires, i.e., the driving wires and switching wires, and drive the wires in a time division manner.

According to claim 3 of the invention, the plurality of switching elements are simply arranged, thereby reducing the number of the signal wires without a complicated circuit configuration.

According to claim 4 of the invention, the TFTs serving as the switching elements can be provided at the same time as TFTs for driving the LCD panel, thereby shortening the manufacturing process.

According to claim 5 of the invention, the number of the signal wires, i.e., the driving wires and switching wires, can be smaller than the number of the signal input terminals, thereby achieving higher space efficiency.

### BRIEF DESCRIPTION OF THE DRAWINGS

FIG. 1 is a circuit diagram showing coupling between signal input terminals of a liquid crystal display apparatus according to one embodiment and signal wires.

FIG. 2 is a timing chart showing the relationship between signals input to each of the signal wires shown in FIG. 1 and signals applied to the signal input terminals of the liquid crystal display panel.

FIG. 3 is a plane view showing a related-art active-matrix liquid crystal display apparatus packaged by chip-on-glass (COG) mounting.

FIG. 4 is an enlarged plane view showing the pattern of signal wires in a peripheral area A12 where scan signal input terminals ta are formed.

FIG. 5 shows coupling between signal input terminals of a related-art liquid crystal display panel and signal wires.

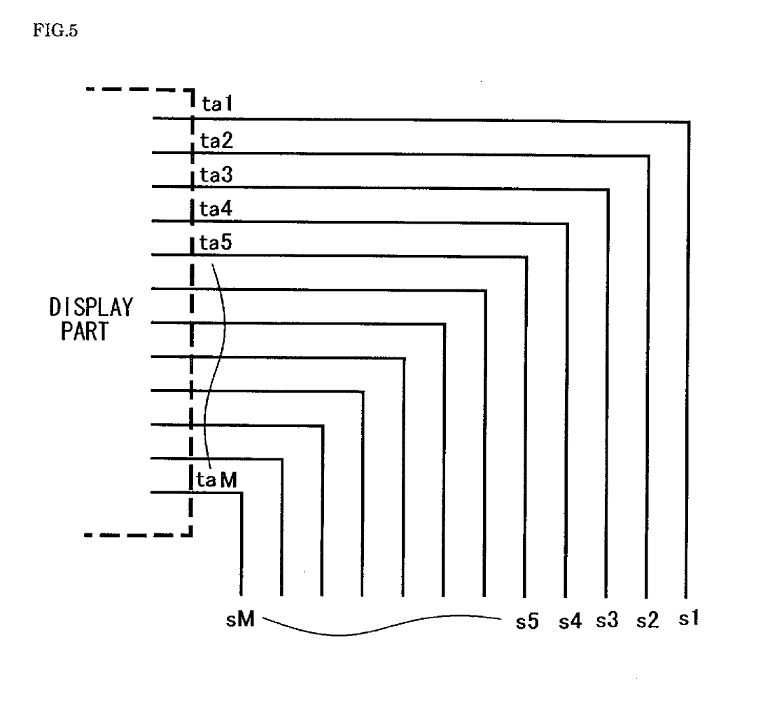

FIG. 6 is a timing chart showing the relationship between signals input to a related-art liquid crystal display apparatus and signals applied to the signal input terminals of the related-art liquid crystal display panel.

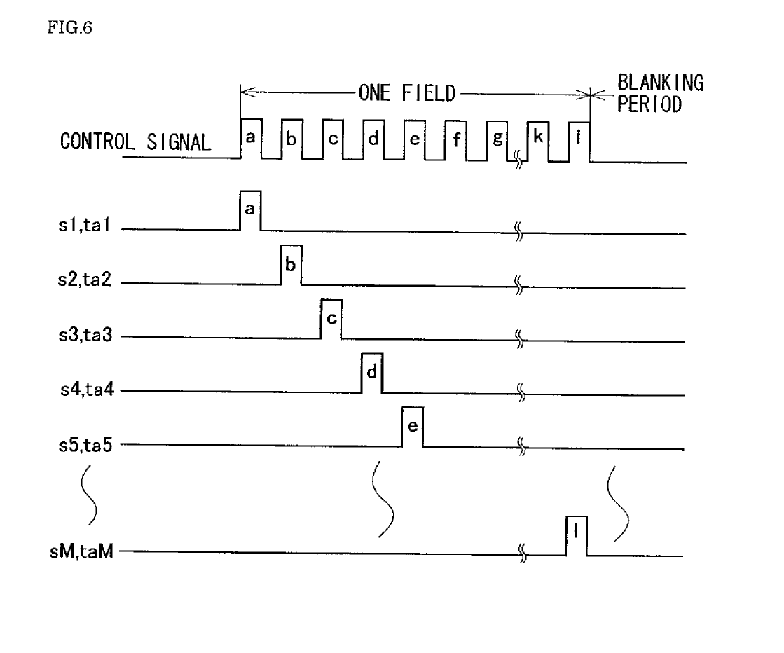

### REFERENCE NUMERALS

32 First board
34 Liquid crystal display (LCD) panel
35, 36, 37 Driving integrated circuit (IC)
38 Common wire
SW1 to SW3 Switching wire
L1 to L4 Driving wire
tr1 to trM Thin film transistor (TFT)
A11, A12, A13 Peripheral area
td Common terminal
tc Common driving signal input terminal
ta1 to taM Signal input terminal

### DESCRIPTION OF THE PREFERRED EMBODIMENTS

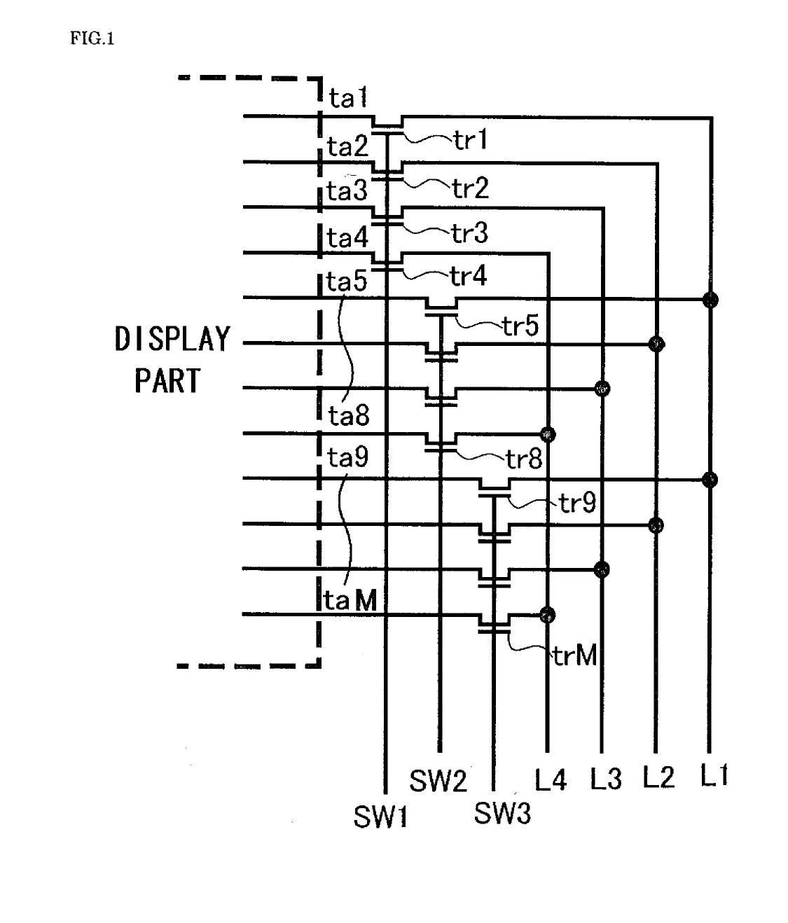

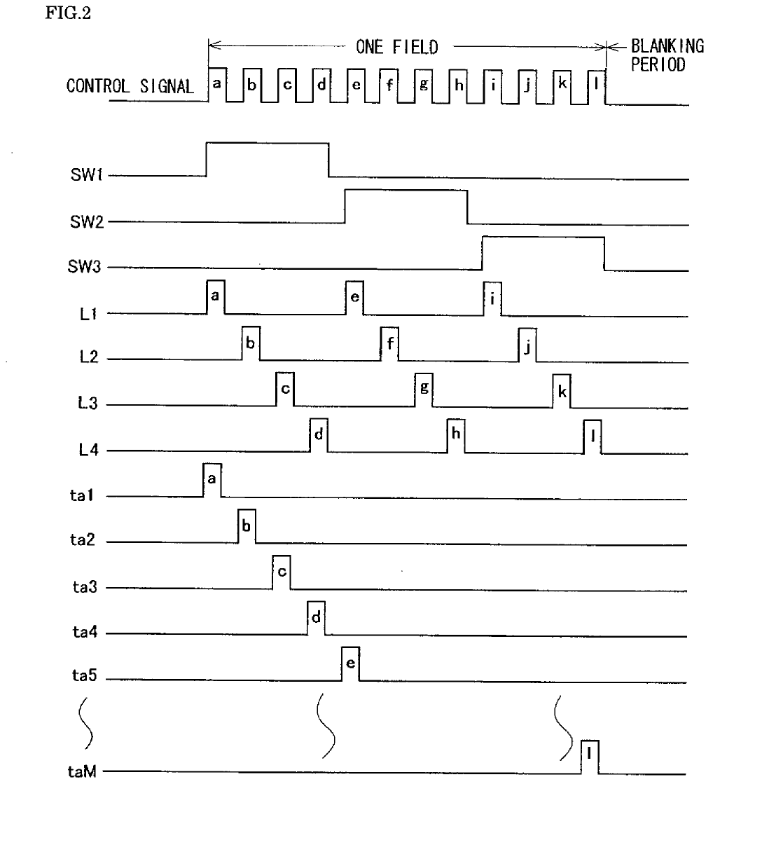

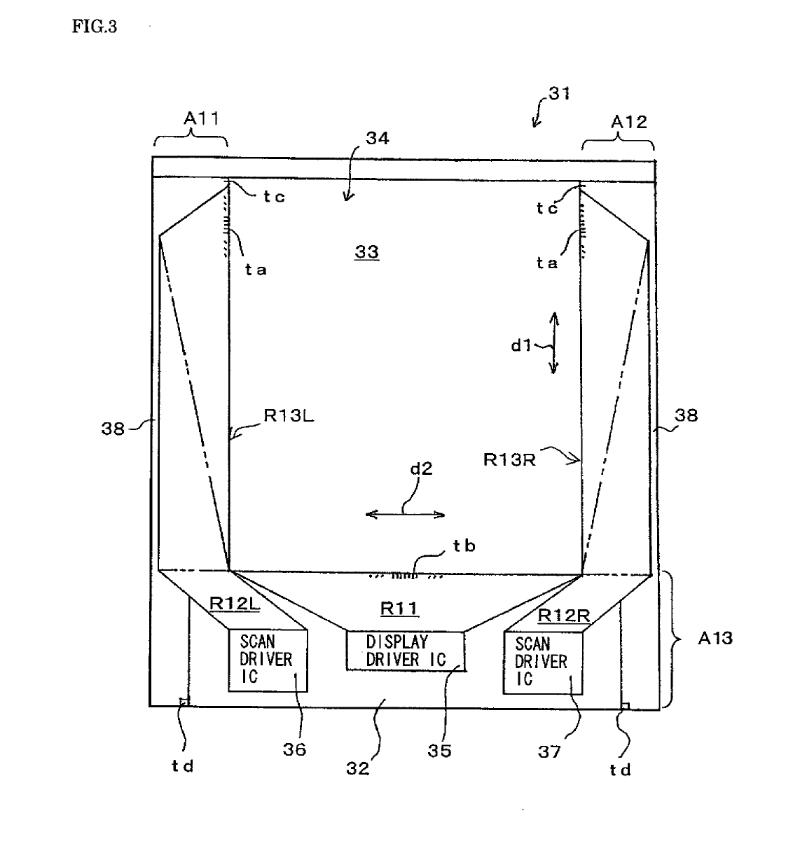

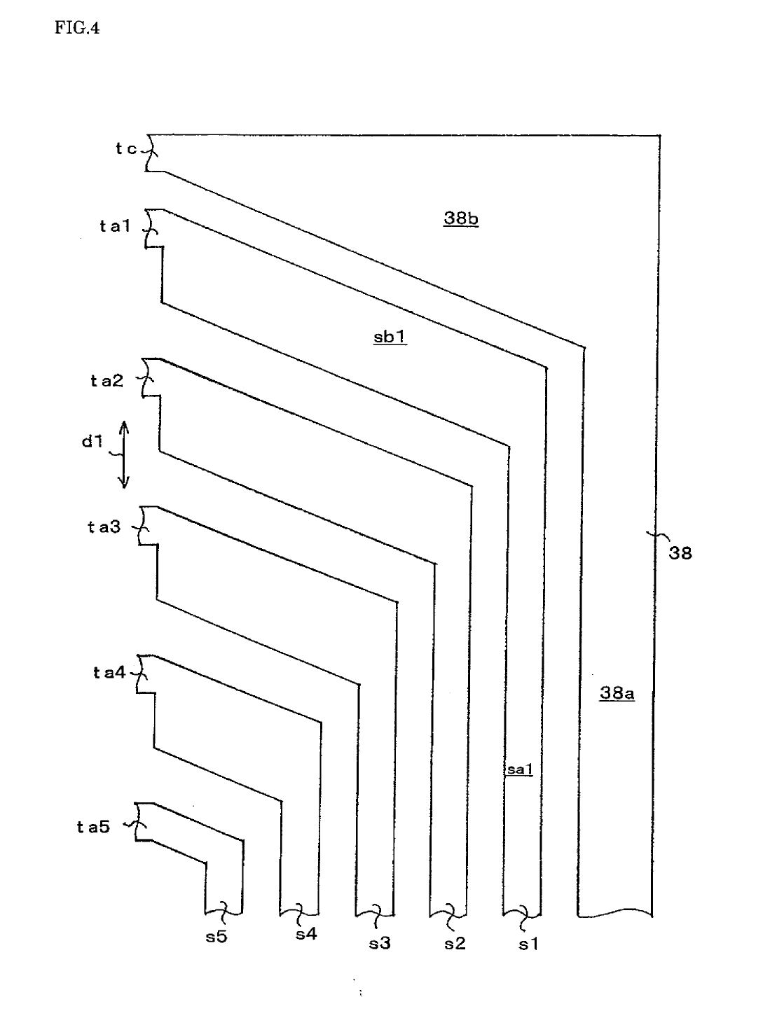

One embodiment of the present invention will now be described with reference to FIGS. 1 and 2, and where necessary with reference to FIGS. 3 and 4 showing a related art employing a basic configuration similar to that of a liquid crystal display (LCD) panel according to the present embodiment. FIG. 1 is a circuit diagram showing coupling between a plurality of signal input terminals and signal wires included in an LCD apparatus according to the present embodiment. FIG. 2 is a timing chart showing the relationship between signals input to each of the signal wires shown in FIG. 1 and signals applied to the signal input terminals ta1 to taM of the LCD panel.

As FIG. 1 shows, the plurality of signal wires included in the LCD apparatus according to the present embodiment include three switching wires SW1 to SW3 and four driving wires L1 to L4, for example. Of the signal input terminals ta1 to taM of the LCD panel, four adjacent input terminals ta1 to ta4 are coupled to the driving: wires L1 to L4 via TFTs tr1 to tr4, respectively. The TFTs tr1 to tr4 serve as switching elements and their input terminals (gate electrodes) are coupled to the switching wire SW1. Likewise, each four of the other signal input terminals ta5 to taM of the LCD panel are coupled to the driving wires L1 to L4, respectively, via TFTs. The TFTs' input terminals are coupled to the switching wire SW2 or SW3.

For the TFTs tr1 to trM, the use of low temperature p-Si (LTPS) TFTs to drive each pixel in an active-matrix-LCD panel has been increasing, which enables the TFTs to be provided at the same time as switching or driving wires.

For example, if the TFTs tr1 to tr4 turn on in response to signals applied to the switching wire SW1, the signal input terminals ta1 to ta4 are coupled to the driving wires L1 to L4, respectively. Accordingly, the input terminals ta1 to ta4 are applied with input signals from the driving lines L1 to L4, respectively. Meanwhile, the other signal input terminals ta5 to taM are applied with no signal, since the switching wires SW2 and SW3 are applied with no signal and accordingly the TFTs tr5 to trM remain off.

If the switching wire SW2 is applied with a signal, making another signal applied to the switching wire SW1 go off, the TFTs tr5 to tr8 turn on while the other TFTs tr1 to tr4 and tr9 to trM turn off. Consequently, the four adjacent signal input terminals ta5 to ta8 are coupled to the driving wires L1 to L4, respectively, whereby the four input terminals ta5 to ta8 are applied with input signals from the driving wires L1 to L4, respectively, while the other input terminals ta1 to ta4 and ta9 to taM are applied with no signal.

In the same manner, if the switching wire SW3 is applied with a signal while the switching wires SW1 and SW2 are applied with no signal, each four of the input terminals ta9 to taM are applied with input signals from the driving wires L1 to L4, respectively, while the other input terminals ta1 to ta8 are applied with no signal.

Referring now to the timing chart of FIG. 2, the relationship between the signals input to each of the signal wires and the signals applied to the signal input terminals ta1 to taM of the LCD panel will be described. In response to control signals a to l, for example, input for one field period by an external controller (not shown), a scan driver IC 37 provided on one board of the LCD panel as shown in FIG. 3 generates control signals whose timings are shown in FIG. 2 to the switching wires SW1 to SW3 and driving wires L1 to L4.

Specifically, the driving signals a, e, and i are output to the driving wire L1, the signals b, f, and j to the wire L2, the signals c, g, and k to the wire L3, and the signals d, h, and l to the wire L4, while limiting outputting from the switching wire SW1 to a first period for inputting the signals a to d, outputting from the wire SW2 to a second period for inputting the signals e to h, and outputting from the wire SW3 to a third period for inputting the signals g to l.

If the TFTs tr1 to tr4 turn on in response to switching signals applied to the switching wire SW1, the signal input terminals ta1 to ta4 of the LCD panel are coupled to the driving wires L1 to L4, respectively, to be applied with driving signals from the driving lines L1 to L4, respectively. Accordingly, the terminals ta1 to ta4 are applied with the driving signals a to d, respectively.

Likewise, in response to the outputs applied successively to the switching wires SW2 and SW3, the input terminals ta5 to taM of the LCD panel are applied with the corresponding driving signals e to l.

According to the present embodiment, when, for example, M is 12 for the plurality of signal input terminals ta1 to taM provided to the periphery of the display part of the LCD panel to receive scan signals or video signals, the seven signal wires, i.e., three switching wires SW1 to SW3 and four driving wires L1 to L4, are used to apply driving signals properly.

With the number N of switching wires, the number P of driving wires, and the number M of signal input terminals of an LCD panel, signal wires are provided without redundancy when the formula M/N≦P is met. Here, the number of signal wires satisfies the formula N+P<M.

Take an example of quarter video graphics array (QVGA) LCD panels, which have 320×240 dots and are typically used in mobile phones. Assuming that the number N of the switching wires is 2, the number P of the driving wires is 160 to drive the 320-dot side (=320) corresponding to scan signal lines in a time division manner, and the signal wires (N+P) total 162. If the number N of the switching wires is 8, the number P of the driving wires is 40, and the signal wires (N+P) total 48. In this manner, the number of the driving wires decreases significantly as the number of the switching wires increases, whereby the resultant number of the signal wires, which is a total of the switching wires and driving wires, decreases significantly.

This decrease in the number of the signal wires is allocated in a balanced manner to have wider common wires and a narrower peripheral area included in an LCD apparatus with such desired characteristics.

While the plurality of driving wires driven in a time division manner may be coupled to either video signal lines or scan signal lines of the LCD panel, it is preferable that the wires be coupled to the scan signal lines receiving digital signals. This is because the signals provided to the video signal lines are analog gradation signals and require a high switching frequency for time division, whereby display quality is likely to deteriorate if switching noise occurs in the gradation signals.

With regard to the number M of the input terminals, for example, the terminals ta1 and taM shown in FIG. 1 are not always used for display purposes, and may be used as dummies.

The number of the driver ICs mounted on the board are not limited to three as in the related-art example shown in FIG. 3. The structure may include two ICs one of which is a scan driver and another of which is a display driver. Instead, the structure may include a single IC that generates and outputs both scan signals and display signals. Furthermore, while the related-art example shown in FIG. 3 involves the three peripheral areas A11, A12, A13 around the display part and the scan signal input terminals ta are arranged in the two opposing peripheral areas A11 and A12, the terminals may be arranged only in one of these areas A11 and A12. The areas A11 and A12 may have different dimensions.

1. A liquid crystal display (LCD) apparatus, comprising:
an LCD panel including a first board and a second board that is smaller than said first board and overlaps said first board with a liquid crystal layer therebetween to provide a display part; and
a plurality of signal input terminals that are provided on said first board side on a periphery of said display part to receive a scan signal or a video signal; and
a common wire provided on said first board side to provide a common electrode provided on said second board side with a common signal;
in said LCD panel, a driver circuit that processes a control signal provided externally and generates a driving signal to drive said LCD panel and a switching signal, a plurality of driving wires through which said driving signal from said driver circuit is sent, and a plurality of switching wires through which said switching signal from said driving circuit is sent, together with said common wire provided along outside of said driving wire, being provided on said first board,
a total of said plurality of driving wires and said plurality of switching wires being less than the number of said plurality of signal input terminals,
each of said plurality of signal input terminals being coupled to said plurality of driving wires via a switching element, and
said plurality of driving wires being synchronized to said switching signal by said switching element and switchingly coupled to said plurality of signal input terminals in a time division manner.

2. The LCD apparatus according to claim 1, wherein with the number of said plurality of driving wires being P and the number of said plurality of switching wires being N,
each P of said plurality of signal input terminals are coupled to said individual driving wires via said switching element,
each of said N switching wires is coupled to an input terminal of said P switching elements coupled to said individual driving wires, and
said switching element is controlled from said driver circuit via said N switching wires and said P driving wires are provided with said driving signal to provide said plurality of signal input terminals with said driving signal in a time division manner.

3. The LCD apparatus according to claim 2, wherein said plurality of signal input terminals each P of which are coupled to said individual driving wires via said switching element are adjacent to each other.

4. The LCD apparatus according to any one of claims 1 to 3, wherein said switching element is a thin film transistor (TFT).

5. The LCD apparatus according to claim 2, wherein with the number of said plurality of signal input terminals being M, said numbers M, N, and P satisfy a formula M/N≦P.
